(19) United States
(12) Patent Application Publication
(10) Pub. No.: US 2001/0043653 A1
(43) Pub. Date: Nov. 22, 2001

(54) METHOD AND APPARATUS FOR IMAGE ENCODING METHOD AND APPARTUS FOR IMAGE DECODING AND RECORDING MEDIUM

(76) Inventor: KAZUHUSA HOSAKA, TOKYO (JP)

Correspondence Address: FROMMER LAWRENCE & HAUG, 745 FIFTH AVENUE- 10TH FL., NEW YORK, NY, 10151, US

(21) Appl. No.: 09/048,134

(22) Filed: Mar. 25, 1998

(30) Foreign Application Priority Data
Mar. 26, 1997 (JP) 9-074195

(51) Int. Cl. H04N 7/12; G06T 9/00; H04B 1/66

(52) U.S. Cl. 375/240.16; 375/240.12; 375/240.02; 382/238; 382/239; 382/236

(57) ABSTRACT

The present invention relates to a technique of encoding each data unit (for example, a block data) of an image and simultaneously, its relevant information indicative of a coding mode of the data unit. In particular, each data unit of the image is encoded in accordance with either the information indicative of a coding mode of each of data units which are highly correlated in space or time to the data unit to be encoded or pixels in decoded data units. Accordingly, the encoding of the image will be executed at higher efficiency.

### BACKGROUND OF THE INVENTION

1. Field of the Invention

The present invention relates to a method and an apparatus for encoding digital image signals, a method and an apparatus for decoding the same, and an image data recording medium which are provided for use in the field of transmitting image signals over transmission systems such as analog or digital telephone networks, specific data transmission lines, or the like having different transmission rates and for recording image signals on storage mediums such as optomagnetic disks, RAMs (random access memories), or the like having different storage capacities.

2. Description of Related Art

Among image encoding methods is an object scalable encoding in which a single image is divided into a group of so-called objects and each object is encoded.

For example, an image VI consisting mainly of a person and a background is divided into two objects, the person and the background, as shown in FIG. 1. The two objects, an image of the person V2 and an image of the background V3, are encoded respectively. This allows the image of the person V2 to be finely quantized and encoded and the image of the background V3 to be roughly quantized and encoded. More particularly, the person object V2 is encoded throughout its frame while the background object V3 is encoded only one of several consecutive frames. This object scalable encoding is advantageous in enhancing the quality of a desired image object in a given amount of data and decreasing the amount of data in a given level of the image quality.

For implementing the object scalable encoding, it is essential to encode the shape of an object in addition to a texture image (or simply a texture) which represents brightness and tone of the encoded object image. The shape of the object is captured in a shape image (or simply a shape or a key signal). In the diagram of FIG. 1, the person object V2 is separated into a texture image V2a and a shape image V2b which are then encoded respectively.

As described, the data of the shape is specified by a hard key signal or a soft key signal. The hard key signal includes a binary image data indicating that covered is either the outside or the inside of the object shape. When the hard key signal indicates that pixels cover the inside of the object shape, the texture image of the object is applied. When the hard key signal indicates the outside of the object shape, the texture image of the background is assigned. On the other hand, the soft key signal represents a multilevel image indicating a ratio in multiple levels between the texture inside the shape and the texture outside the shape. When pixels are specified by the maximum value of the soft key signal, they are provided with the texture image of the object. When specified by the minimum value, pixels are filled with directly the texture image of the background. If pixels are specified by intermediate values, they display composite texture image data having both the object and the background at a corresponding ratio.

A common system for transmitting or storing motion image signals employs intraframe or interframe correlation in the motion image signals for compressing and encoding data of the signals, thus allowing its transmission lines or storage mediums to be utilized at optimum efficiency. One of the most popular methods of compressing and encoding data of a motion image signal has been developed and standardized by an international committee of specialists known as MPEG (Moving Picture Image Coding Experts Group). The MPEG standard is a hybrid encoding method including substantially DCT (discrete cosine transform), and motion compensative prediction coding.

In the method of encoding motion image signals with intraframe correlation, data of the texture is encoded by an orthogonal transform technique such as DCT where coefficients to be encoded are concentrated while data of the shape is encoded by MMR (modified modified read) or JBIG (joint bi-level image coding experts group).

In the method with interframe correlation, motion compensation predictive coding is mainly used. The principle of the motion compensation interframe predictive coding is now explained referring to FIG. 2.

As shown in FIG. 2, two images PI and P2 have been introduced at the timing t1 and t2 respectively and it is assumed that while the image P1 has been encoded and transmitted, the image P2 is ready for being encoded and transmitted. The image P2 is divided into a number of blocks and each block is examined to determine a motion convolution (a motion vector) over the preceding image P1. A predictive image for the block is established by shifting the image P with the motion vector. A difference between the predictive image and the block of the image P2 is then calculated. Both the difference image and the motion vector are encoded and transmitted by the motion compensative interframe coding.

FIG. 3 illustrates a block diagram of an encoding apparatus for encoding the shape in an image with the help of motion compensative interframe prediction and motion vector prediction. This encoding apparatus employs the MPEG encoding standard in which data is processed in macroblocks. The shape in the image is not encoded throughout a frame size. As shown in FIG. 4, the frame is trimmed to, for example, a rectangular area of the object (which defines the shape of a person of the object in FIG. 4). The rectangular area is also called a VOP (video object plane).

The shape encoding apparatus shown in FIG. 3 encodes data of the shape in the image introduced from its shape input terminal 41 and delivers its encoded form from a code output terminal 50.

More specifically, the shape data received by the shape input terminal 41 is supplied to a motion detector 42 and a shape encoder 44.

The motion detector 42 examines a motion in each macroblock between the supplied shape data and a locally decoded shape data which has been encoded by the shape encoder 44, locally decoded, and saved in a locally decoded image memory 45. A resultant motion vector representing the motion is then released together with a mode of the macroblock, and a coordinate at the upper left corner of the macroblock. The mode of the macroblock will be described later.

The mode of the macroblock is transferred to a mode memory 46 and a mode encoder 47 as well as the shape encoder 44. The coordinate at the upper left corner of the macroblock is fed to the mode encoder 47. The motion vector is supplied to a motion vector encoder 48 and a motion compensator 43. The motion vector encoder 48 encodes the motion vector and delivers its encoded form to a multiplexer 49. The motion compensator 43 produces a predictive shape data from the locally decoded data saved in the locally decoded image memory 45 on the basis of the motion vector and delivers it to the shape encoder 44. In the shape decoder 44, the shape data is encoded according to the predictive shape data and the mode of the macroblock and transferred to the multiplexer 49. Also, the shape encoder 44 decodes locally the encoded shape data and feeds its locally decoded form to the locally decoded image memory 45.

The mode of the macroblock of the shape data may be classified into five modes; MO indicating that all the pixels in a macroblock are outside the shape of the object, M1 indicating that all the pixels in a macroblock are inside the shape of the object, and Mintra indicating that the data in each frame is encoded (by intraframe correlation), and Minter indicating that the data is encoded with reference to the motion compensated shape data (by interframe correlation), and Mskip indicating that the motion compensated shape data is directly used. It is also possible to classify the mode of the macroblock depending on whether the motion vector is transmitted or not.

The mode encoder 47 encodes the mode of the macroblock supplied according to the mode of a corresponding macroblock in a (reference) frame. More particularly, the mode of the corresponding macroblock from the motion detector 42 has been applied and saved in the mode memory 46 as the mode of a reference macroblock. The mode memory 46 has also been supplied with parameters x_org(t), y_org(t), w(t), and h(t) which indicate the size of the VOP (a rectangular area) in each frame. The two parameters x_org(t) and y_org(t) are coordinate values at the upper left corner of the rectangular area of VOP in the frame at the timing t. The parameter w(t) represents a width of the rectangular area and h(t) represents a height of the same. Those parameters can be used for specifying the rectangular area of VOP. In action, the mode encoder 47 receives the coordinate values at the upper left corner of the VOP of the reference frame from the mode memory 46 and the coordinate values at the upper left corner of the macroblock of interest to be encoded and the mode of the same from the motion detector 42. The reference macroblock is then calculated using a reference macroblock determining method which is saved in the mode encoder 47 and will be explained later in more detail. The mode of the reference macroblock in the reference frame is retrieved from the mode memory 46 and used by the mode encoder 47 encoding the mode of the macroblock of interest.

More particularly in the mode encoder 47, the mode of the macroblock of interest is encoded by e.g. VLC (variable length coding) examining the mode of the reference macroblock in the reference frame to select a desired VLC table which can allocate a short length code when the mode to be encoded is identical to that of the reference macroblock in the reference frame. If the mode is encoded by arithmetical encoding, a proper probability table is selected and used. The encoded mode of the macroblock of interest is then transferred to the multiplexer 49.

The multiplexer 49 receives the encoded shape data from the shape encoder 44, the encoded motion vector of each macroblock from the motion vector encoder 48, and the encoded mode of the macroblock from the mode encoder 47 which are multiplexed to a stream of coded bits and released out from a code output terminal 50. The bit stream is further transmitted to a receiver via a transmission line not shown or recorded on a recording medium by a recording apparatus.

The encoding of the mode of the macroblock is now explained in more detail. As described previously. the mode of the macroblock of interest is encoded in respect to the mode of the reference macroblock in the reference frame. The shape data is encoded throughout the rectangular area (of VOP) which defines the shape of the object. FIG. 4A shows the rectangular area at the timing t=1 and FIG. 4B shows the same at the timing t=2.

As apparent from FIGS. 4A and 4B, the coordinate values at the upper left of the rectangular area and the size (of the rectangular area) of VOP to be encoded are varied depending on the frame. At t=1, the rectangular area of VOP shown in FIG. 4A has coordinate values of x_org(1) and y_org(1) at the upper left corner, a width of w(1), and a height of h(1). At t=2, the rectangular area of VOP shown in FIG. 4B has coordinate values of x_org(2) and y_org(2), a width of w(2), and a height of h(2). It is clear that the coordinate values at the upper left corner and the size of the rectangular area are different between the two frames.

Accordingly, the relation between the macroblock of interest to be encoded and the reference macroblock in the reference frame will hardly be constant.

This drawback will be explained in more detail referring to FIG. 5. FIG. 5 illustrates an object (for example, a person) in each of three consecutive frames at t=0, t=1, and t=2 and a rectangular area of VOP in which the person of the object is contained. The rectangular area consists of a number of macroblocks providing a grid array.

At t=0, the person of the object stands with its (two) arms extending horizontally as shown in FIG. 5A. As the time runs from t=1 to t=2, the left arm of the person (when viewed from this side) is being lifted up as shown in FIGS. 5B and 5C. It is apparent from FIGS. 5A, 5B, and 5C that the motion of the person of the object varies the coordinates values at the upper left corner, the width, and the height of the rectangular area of VOP. The frame shown in FIG. 5C is identical to that shown in FIG. 5D. Also, the frame shown in FIG. 5B is similar to that shown in FIG. 4A. The frames shown in Figs. 5C and 5D are similar to that shown in FIG. 4B.

For encoding each macroblock in the rectangular area of the frame at t=1 shifted from at t=0, the mode of the macroblock in the rectangular area in the frame at t=1 has to determined according to whether the object is present or not and the motion (a change) of the object in the macroblock as compared with those in the reference macroblock in the preceding frame at t=0. When the object (or a part of the object) is not present in the macroblock of the rectangular area of the frame at t=1, the mode is selected M0 as best shown in FIG. 5B (where M0 is denoted by only 0). When the motion of the object is not changed from that of the preceding frame, the mode of the macroblock is Mskip (denoted by S in FIG. 5). When the motion of the object is slightly changed from that of the preceding frame, the mode is selected Minter (denoted by I in FIG. 5). When the motion of the object is greatly changed from that of the preceding frame, the mode is Mintra (denoted by C in FIG. 5). As apparent, the coordinate values at the upper left corner, the width, and the height of the rectangular area are unchanged between FIGS. 5A and 5B.

For encoding the macroblock in the rectangular area of the frame at t=2, it is necessary to acknowledge that the coordinate values, width, and height of the rectangular area are different between FIGS. 5B and 5C. When the macroblocks in the rectangular area of the frame at t=2 are encoded, their modes are preferably assigned as shown in FIG. 5C.

It is however true that the mode of the reference macroblock in the reference frame is systematically referred to determine the mode of the macroblock of interest. To determine the mode of the macroblock in the rectangular area of the frame at t=2, the mode of the corresponding macroblock in the preceding frame at t=1 (shown in FIG. 5B) is reviewed as shown in FIG. 5D. More specifically, although the rectangular area of the macroblocks in the frame at t=2 to be encoded has the coordinate values of x_org(2) and y org(2) at the upper left corner, the width of w(2), and the height of h(2) and is not identical to that of the preceding frame at t=1 having the coordinate values of x_org(1) and y org(1), the width of w(1), and the height of h(1), the modes of the macroblocks in the reference or preceding frame at t=1 which are equally allocated in both the horizontal and vertical directions are used without regarding the difference between the two rectangular areas at t=1 and t=2. The mode of each macroblock located outside the rectangular area of VOP at t=1 should be identical to that of the macroblock in the rectangular area of VOP where the object is not present.

As apparent from the comparison between FIGS. 5C and 5D, some reference macroblocks in FIG. 5D exhibit incorrect modes.

The determination of reference macroblocks for the macroblocks in the rectangular area of the frame at t=2 is actually carried out by the mode encoder 47 shown in FIG. 3. More specifically, for determining the reference macroblock corresponding to the macroblock of interest to be encoded, a procedure shown in the flowchart of FIG. 6 is used with the coordinate values x(t) and y(t) at the upper left corner of the macroblock to be encoded and the coordinate values of x_org(t) and y_org(t) at the upper left corner, the width of w(t), and the height of h(t) of the rectangular area in the reference frame saved in the mode memory 46. The flowchart shown in FIG. 6 is provided for calculating the x coordinate of the reference macroblock.

As shown in FIG. 6, assuming that the coordinate values at the upper left corner of the rectangular area (of VOP) in the frame at t=1 are x_org(1) and y_org(1), the coordinate values at the upper left corner of the rectangular area (of VOP) in the frame at t=2 are x_org(2) and y_org(2), and the coordinate values at the upper left corner of the macroblock to be encoded in the rectangular area in the frame at t=2 are x(2) and y(²), Step ST1 calculates x(2)-x_org(2) from the x coordinate value x(2) at the upper left corner of the macroblock to be encoded and the x coordinate value x_org(2) at the upper left corner of the rectangular area in the frame at t=2 and then compares its result with w(1) which is the width of the rectangular area in the reference frame at t=1. When (x(2)-x_org(2))<w(1), the procedure goes to Step ST2 and otherwise, to Step ST3.

At ST2, x_org(1)+x(2)−x_org(2) is calculated from the coordinate value x_org(1) at the upper left corner of the rectangular area (of VOP) in the reference frame at t=1, the x coordinate value x(2) at the upper left corner of the macroblock to be encoded in the rectangular area of the frame at t=2, and the x coordinate value x_org(2) at the upper left corner of the rectangular area in the frame at t=2. Accordingly, the x coordinate value x(1) at the upper left corner of the macroblock to be encoded in the rectangular area of the frame at t=1 is given.

At ST3, x₁₃ (1)+w(1)−16 is calculated from the coordinate value x_org(1) at the upper left corner of the rectangular area (of VOP) in the reference frame at t=1, the width w(1) of the rectangular area of the frame at t=1, and 16 which represents the number of pixels arranged in the horizontal direction in the macroblock to be encoded. Accordingly, the x coordinate value x(1) at the upper left corner of the reference macroblock in the rectangular area of the frame at t=1 is given.

The above description involves calculation in the x direction. The y coordinate value y(1) at the upper left corner of the reference macroblock in the rectangular area of the frame at t=1 can equally be calculated by substituting w(1) with h(1).

An arrangement and an operation of a conventional decoding apparatus for decoding the encoded bit stream produced by the encoder shown in FIG. 3 is explained referring to FIG. 7.

The shape decoding apparatus shown in FIG. 7 is designed for decoding the encoded form of the shape data received at a code input terminal 80 and releasing its decoded form from a shape output terminal 88. Similar to the encoding of the encoding apparatus, the decoding is carried out in reference to the mode of a reference macroblock.

As shown in FIG. 7, a code received at the code input terminal 80 is separated by a demultiplexer 81 to a shape data code, a motion vector code, and a macroblock mode code.

The separated codes are transferred to a shape decoder 84, a motion vector decoder 82, and a mode decoder 87 respectively.

The motion vector decoder 82 decodes the motion vector code and transmits its decoded data to a motion compensator 83. The mode decoder 87 decodes the mode code according to the mode of a reference macroblock in a reference frame which has been decoded and saved in a mode memory 86. In the decoding of the mode decoder 87, the corresponding or reference macroblock is determined by the same manner as of determining the reference macroblock in the mode encoder 47. The reference macroblock is retrieved from the mode memory 46 and its mode is used in the decoding.

The decoded mode of the macroblock produced by the mode decoder 87 is transferred to both the shape decoder 84 and the mode memory 86 where it is saved as the mode of the reference macroblock in the reference frame. In the mode memory 86, the coordinate values of x_org(t) and y_org(t) at the upper left corner, the width of w(t), and the height of h(t) of the rectangular area of VOP are also saved. Those parameters are used for specifying each rectangular area of VOP.

The motion compensator 83 produces a predictive shape data from a decoded shape data which has been reconstructed by the shape decoder 84 using the motion vector from the motion vector decoder 82 and saved in a decoded image memory 85. The predictive shape data is then supplied to the shape decoder 84.

The shape decoder 84 receives the shape data code, the decoded mode of the macroblock from the mode decoder 87, and the predictive shape data from the motion compensator 83. The shape decoder 84 decodes the shape data code of each macroblock according to the decoded mode of the macroblock and the predictive shape data. A resultant decoded form of the shape data is transferred via a shape output terminal to the outside. The shape data is also fed to the decoded image memory 85 where it is saved for future use in the motion compensator 83 to produce a predictive shape data.

As described, the encoding apparatus shown in FIG. 5 may have the mode of the reference macroblock to be diverted when the coordinate values at the upper left of the rectangular area of VOP are not identical between the frame to be encoded and the reference frame. thus declining the efficiency of coding operation.

In addition, the motion vector encoding for motion compensation permits the change from the upper left of the full frame to be encoded not the change from the upper left of the rectangular area of VOP, hence creating discrepancy between the motion vector and the mode of the macroblock.

### SUMMARY OF THE INVENTION

It is thus an object of the present invention to provide a method and an apparatus for encoding image data at higher efficiency, a method and an apparatus for decoding coded image data at higher accuracy, and a recording medium on which coded image data capable of being reproduced by a playback apparatus is stored at higher efficiency.

A method and an apparatus for encoding an image according to the present invention is featured by encoding each data unit of the image to be encoded in accordance with a reference image in time and also, encoding its relevant information indicative of a coding mode of each data unit of the image to be encoded in accordance with information indicative of a coding mode of a corresponding data unit of a reference image which is most analogous to the data unit of the image to be encoded.

A method and an apparatus for decoding an image according to the present invention is featured by decoding relevant information indicative of a coding mode of each data unit of the image to be decoded in accordance with information indicative of a coding mode of a corresponding data unit of a reference image which is most analogous to the data unit of the image to be decoded and also, decoding each data unit of the image in accordance with the decoded relevant information indicative of a coding mode of the data unit and the reference image in time.

Another method and another apparatus for encoding an image according to the present invention is featured by encoding each data unit of the image to be encoded and also, encoding its relevant information indicative of a coding mode of each data unit of the image to be encoded in accordance with information indicative of a coding mode of each of data units which are spatially adjoined to the data unit of the image to be encoded.

Another method and another apparatus for decoding an image according to the present invention is featured by decoding relevant information indicative of a coding mode of each data unit of the image to be decoded in accordance with information indicative of a coding mode of each of data units which are spatially adjoined to the data unit of the image to be decoded and also, decoding each data unit of the image in accordance with the decoded relevant information indicative of a coding mode of the data unit.

A further method and a further apparatus for encoding an image according to the present invention is featured by encoding each data unit of the image to be encoded and also, encoding its relevant information indicative of a coding mode of each data unit of the image to be encoded in accordance with pixels in locally decoded data units which are spatially adjoined to the data unit of the image to be encoded.

A further method and a further apparatus for decoding an image according to the present invention is featured by decoding relevant information indicative of a coding mode of each data unit of the image to be decoded in accordance with pixels in locally decoded data units which are spatially adjoined to the data unit of the image to be decoded and also, decoding each data unit of the image in accordance with the decoded relevant information indicative of a coding mode of the data unit.

A recording medium according to the present invention is featured on which a coded signal capable of being decoded by the image decoding method of the present invention is stored.

### BRIEF DESCRIPTION OF THE DRAWINGS

FIG. 1 is an explanatory view showing separation of an image into objects;

FIG. 2 is an explanatory view showing the principle of motion compensative interframe prediction;

FIG. 3 is a block diagram of an arrangement of a conventional shape encoding apparatus;

FIG. 4 is an explanatory view showing the area of VOP;

FIG. 5 is an explanatory view showing the mode of a reference macroblock used in the shape encoding apparatus;

FIG. 6 is a flowchart showing a procedure for determining the reference macroblock used in the shape encoding apparatus;

FIG. 7 is a block diagram of an arrangement of a conventional shape decoding apparatus;

FIG. 8 is a block diagram of an arrangement of a shape encoding apparatus according to a first embodiment of the present invention;

FIG. 9 is a block diagram of an arrangement for determining a reference macroblock mounted in a mode encoder of the shape encoding apparatus of the first embodiment;

FIG. 10 is a diagram explaining the mode of the reference macroblock;

FIG. 11 is a block diagram of an arrangement of a shape decoding apparatus according to the first embodiment of the present invention;

FIG. 12 is a block diagram of a schematic arrangement of a shape encoding apparatus according to a second and a third embodiment of the present invention;

FIG. 13 is an explanatory view showing the mode of reference in the second and third embodiments; and

FIG. 14 is a block diagram of an arrangement of a shape decoding apparatus according to the second and third embodiments of the present invention.

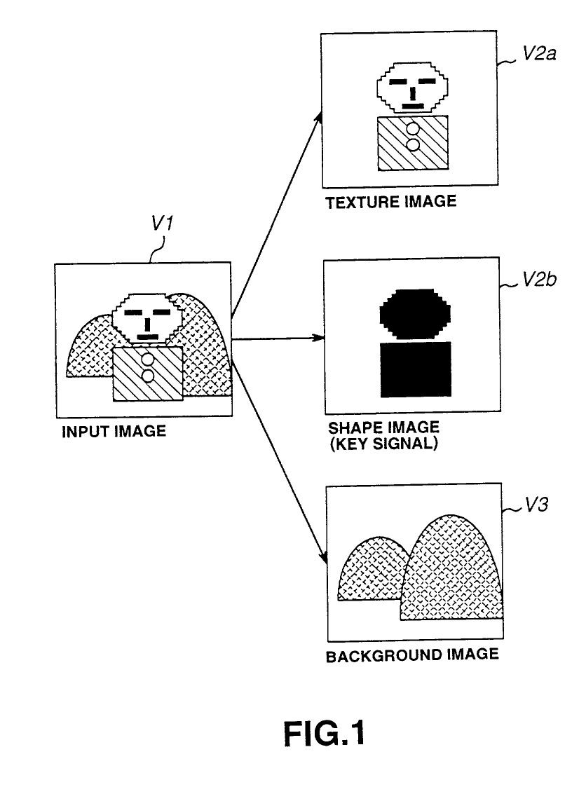

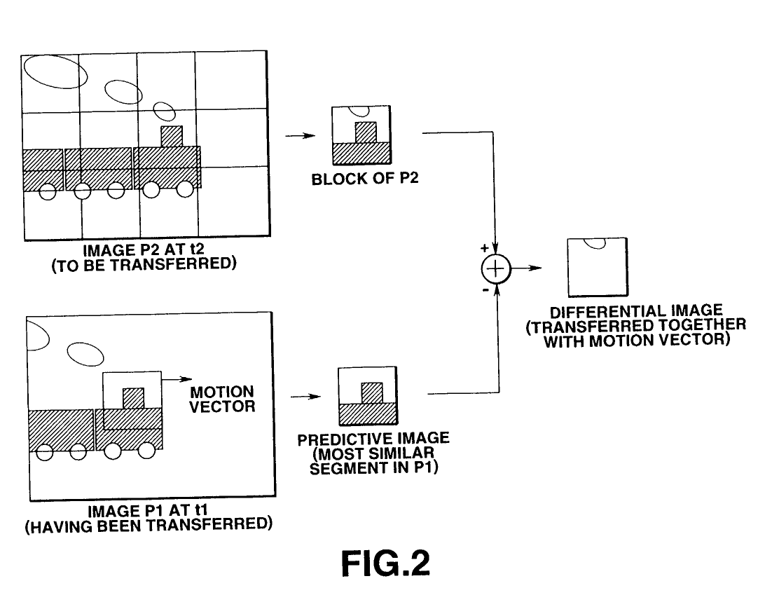

### DESCRIPTION OF PREFERRED EMBODIMENTS

Preferred embodiments of the present invention will be described referring to the accompanying drawings.

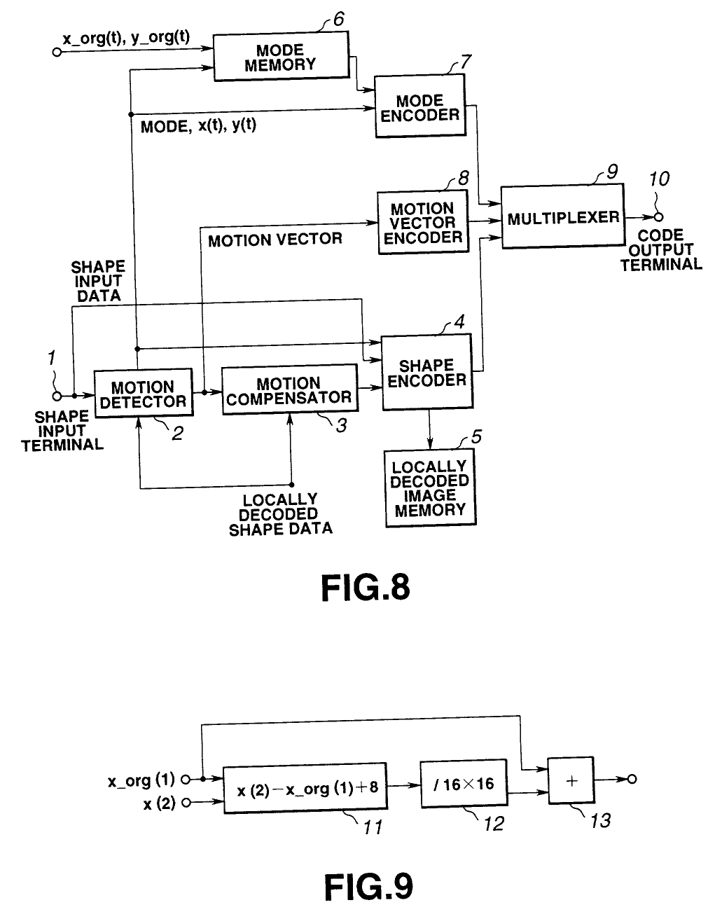

A method of image encoding according to the present invention is carried out by an image encoding apparatus (a shape encoding apparatus) shown as a first embodiment in FIG. 8. The shape encoding apparatus encodes shape data of a motion image received at a shape input terminal 1 and releases it from a code output terminal 10. The encoding operation of the shape encoding apparatus is implemented on the basis of a macroblock by a hybrid encoding method (for example, of the MPEG standard) including DCT and motion compensative prediction encoding. The shape data is encoded over not the entire of a frame but a rectangular area (VOP) in which the object is defined.

The shape data received at the shape input terminal 1 is transferred to a motion detector 2 and a shape encoder 4.

The motion detector 2 examines a motion of image between the shape data and a locally decoded data which has been locally decoded from a coded form produced by the shape encoder 4 and saved in a locally decoded image memory 5. A resultant motion vector is released together with the mode of each macroblock. The modes of the macroblocks are identical to those described previously and will be explained in no more detail.

The mode of each macroblock is supplied to a mode memory 6 and a mode encoder 7 as well as the shape encoder 4. The motion vector from the motion detector 2 is transmitted to a motion compensator 3 and a motion vector encoder 8. The motion vector encoder 8 encodes the motion vector and delivers its encoded form to a multiplexer 9. The motion compensator 3 produces a predictive shape data from the locally decoded shape data saved in the locally decoded image memory 5 with reference to the motion vector and delivers it to the shape encoder 4 where it is used together with the mode of the macroblock for encoding the shape data. An encoded shape data is then supplied to the multiplexer 9. Also, the shape encoder 4 locally decodes the encoded shape data and delivers a locally decoded shape data to the locally decoded image memory 5.

The mode of the macroblock produced by the motion detector 2 is provided to the mode memory 6 and the mode encoder 7. The mode memory 6 saves the mode of the macroblock as the mode of a reference macroblock in the reference frame. Also, parameters x_org(t), y_org(t), w(t), and h(t) are supplied and saved in the mode memory 6 as the reference frame parameters. The parameters are indicative of the size of (the rectangular area of) VOP. More specifically, the parameters x₁₃ (t) and y_org(t) are coordinate values at the upper left corner of the rectangular area of VOP in a frame at the timing t. The parameter w(t) is a width of the rectangular area and h(t) presents a height of the rectangular area. Those parameters are used for specifying the rectangular area of VOP.

The mode encoder 7 encodes the mode of the macroblock according to the mode of the reference macroblock in the (reference) frame cited. The mode encoder 7 also determines the reference macroblock from the coordinate values at the upper left corner of the VOP of the reference frame and the coordinate values at the upper left corner of the macroblock to be encoded. The mode of the macroblock can thus be encoded according to the mode of the reference macroblock in the reference frame.

More particularly in the mode encoder 7, the mode of the macroblock of interest is encoded by e.g. VLC (variable length coding) examining the mode of the reference macroblock in the reference frame to select a desired VLC table which can allocate a short length code when the mode to be encoded is identical to that of the reference macroblock in the reference frame. If the mode is encoded by arithmetical encoding, a proper probability table is selected and used. The action of the mode encoder 7 will be explained later in more detail. The encoded mode of the macroblock of interest is then transferred to the multiplexer 9.

The multiplexer 9 receives the encoded shape data from the shape encoder 4, the encoded motion vector of each macroblock from the motion vector encoder 8, and the encoded mode of each macroblock from the mode encoder 7 which are multiplexed to a stream of coded bits and released out from a code output terminal 10.

The coded bit stream is added with error correction codes, subjected to particular modulations, and recorded by a recording apparatus not shown onto an image recording medium of the present invention such as CD-ROM (compact disk read only memory), DVD (digital versatile disk), optical disk, magnetic disk, optomagnetic disk, RAM, or the like, or further transmitted to a receiver at the other end of a transmission medium.

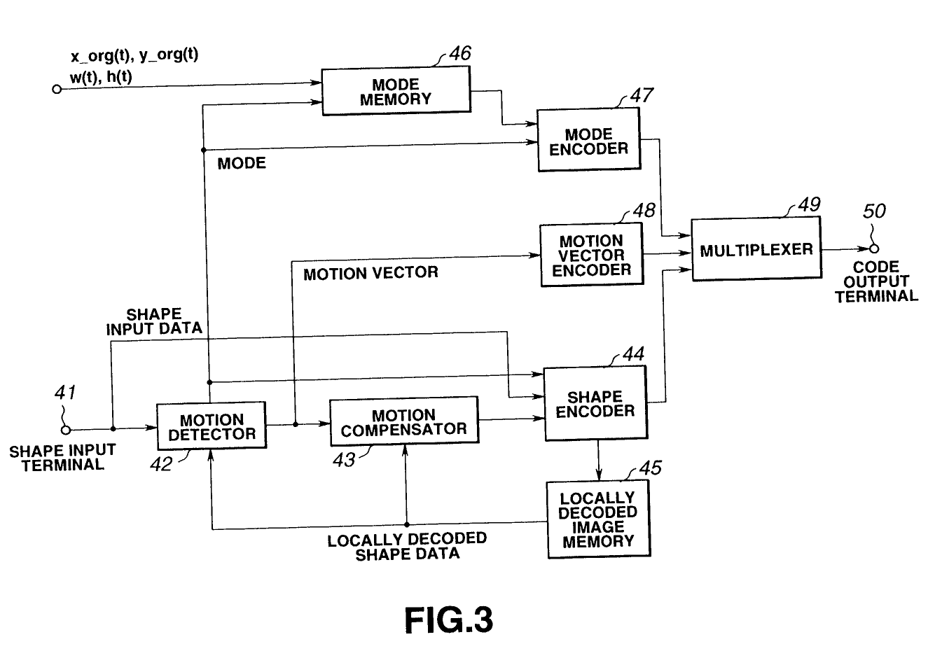

In the encoding apparatus in FIG. 8 in the embodiment of the present invention, the macroblock of the reference frame which is referenced when the mode of the macroblock is encoded is different from the one in the encoding apparatus in FIG. 3. In the following, the encoding of the mode encoder 7 is explained in detail.

In the mode encoder 7 of the shape encoding apparatus of the first embodiment, the encoding of the mode of the macroblock is performed with reference to the mode of the corresponding macroblock in the reference frame which is most analogous to the macroblock to be encoded and its efficiency will thus be increased.

The mode of the macroblock to be encoded and the coordinate values at the upper left corner of the same macroblock are supplied to the mode encoder 7 together with the coordinate values at the upper left corner of the VOP in the reference frame. In response, the reference macroblock to be cited is determined from the coordinates values at the upper left corner of the VOP in the reference frame and the coordinate values at the upper left corner of the macroblock to be encoded by a reference macroblock determining unit, described later, in the mode encoder 7. The mode of the reference macroblock is then read from the mode memory 16. According to the mode of the reference macroblock in the reference frame, the mode of the macroblock is encoded by the mode encoder 7.

An arrangement of the reference macroblock determining unit 14 in the mode encoder 7 is now explained referring to FIG. 9. FIG. 9 illustrates the determination of an x coordinate value of the reference macroblock, in which (x(t), y(t)) are coordinate values at the upper left of the macroblock in the rectangular area (of VOP) in the frame at the timing t and (x_org(t), y_org(t)) are coordinate values at the upper left of the rectangular area (of VOP) in the frame at the timing t. It is assumed in FIG. 9 that two consecutive frames are developed succeedingly at t=1 and t=2.

As shown in FIG. 9, x(2)-x_(1)+8 is calculated by an arithmetic unit 11 where x_org(1) is an x coordinate value at the upper left corner of the rectangular area of the frame at t=1, x(2) is an x coordinate value at the upper left corner of the macroblock, at the upper left, in the rectangular area of the frame at t=2, and 8 is equal to a half the number of pixels along the horizontal direction of the macroblock. A result A is transferred to another arithmetic unit 12 where the result A calculated by the unit 11 is divided by 16, rounded down by eliminating its fraction, and multiplied by 16. An output of the arithmetic unit 12 is added with x_org(1) by a further arithmetic unit 13. A result represents the x coordinate x(1) at the upper left corner of the reference macroblock in the rectangular area of the frame at t=1.

In the circuit shown in FIG. 9, the x coordinate x(1) at the upper left corner of the reference macroblock located at the upper left corner of the rectangular area of the frame at t=1. Although the circuit shown in FIG. 9 calculates along the horizontal direction (or the x axis), it may also determine the y coordinate value along the vertical direction (or the y axis), at the upper left corner of the reference macroblock in the rectangular area of the frame at t=1, from y_org(1) and y(2).

The above is expressed by the following equations (1) and (2).

x(1)=x_org(1)+(x(2)−x_org(1)+8)/16×16 (1)

y(1)=y_org(1)+(y(2)−y_org(1)+8)/16×16 (2)

The calculation of (/16×16) in the arithmetic unit 12 can be implemented by replacing four of the least bits in a binary output of the arithmetic unit 11 with 0s.

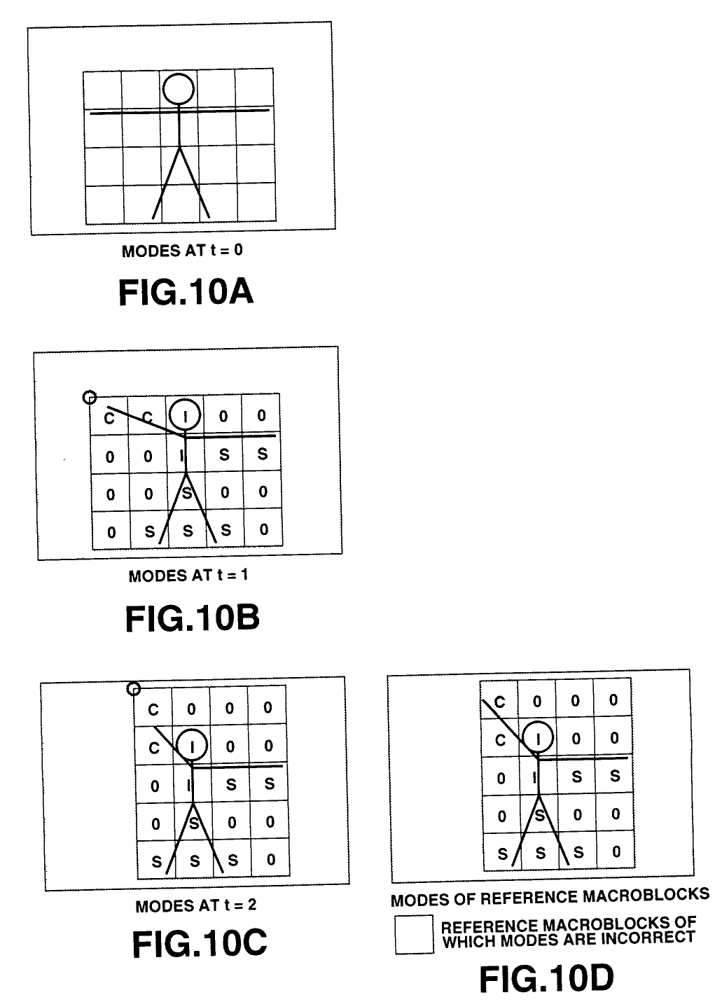

According to the reference macroblock determining method, the mode of the reference macroblock is most certainly given correct as shown in FIG. 10 and the number of bits required for the encoding will be minimized.

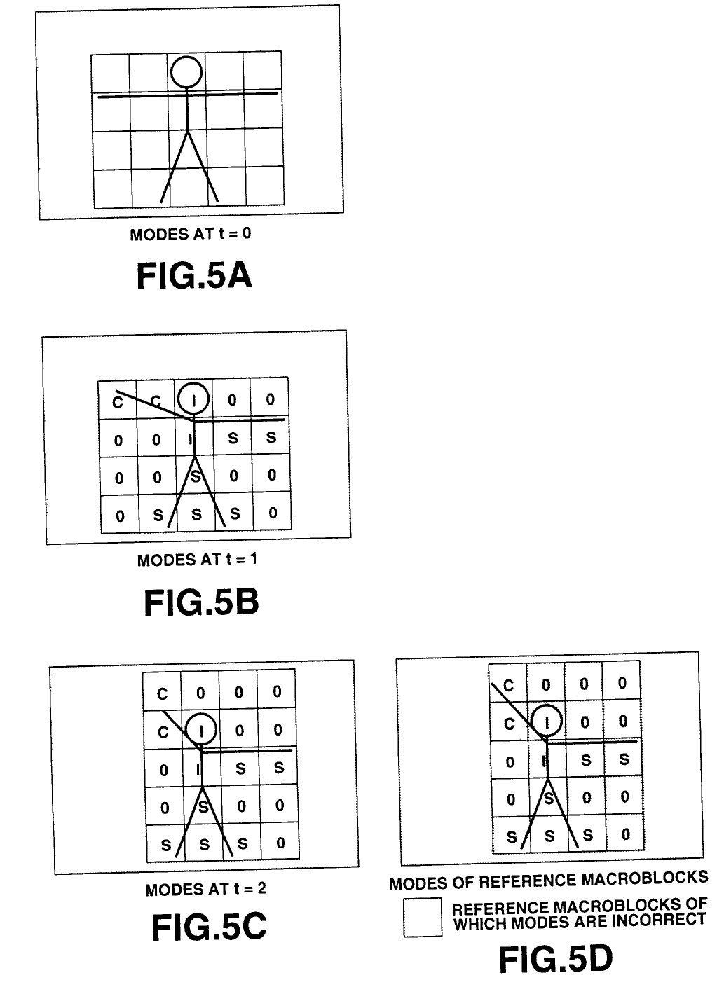

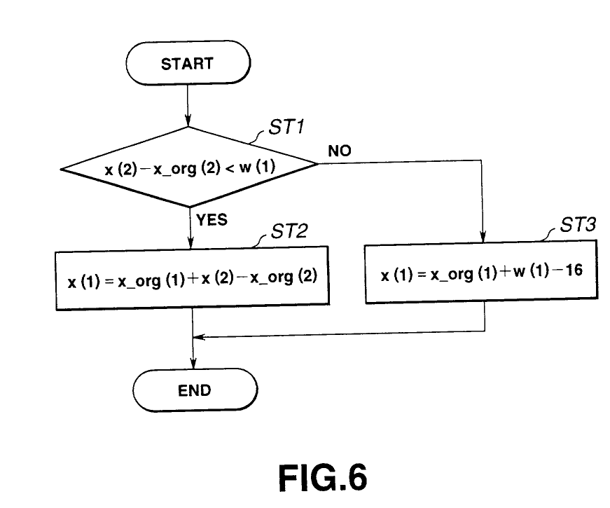

FIGS. 10A, 10B, 10C, and 10D are similar to those shown in FIGS. 5A, 5B, 5C, and 5D.

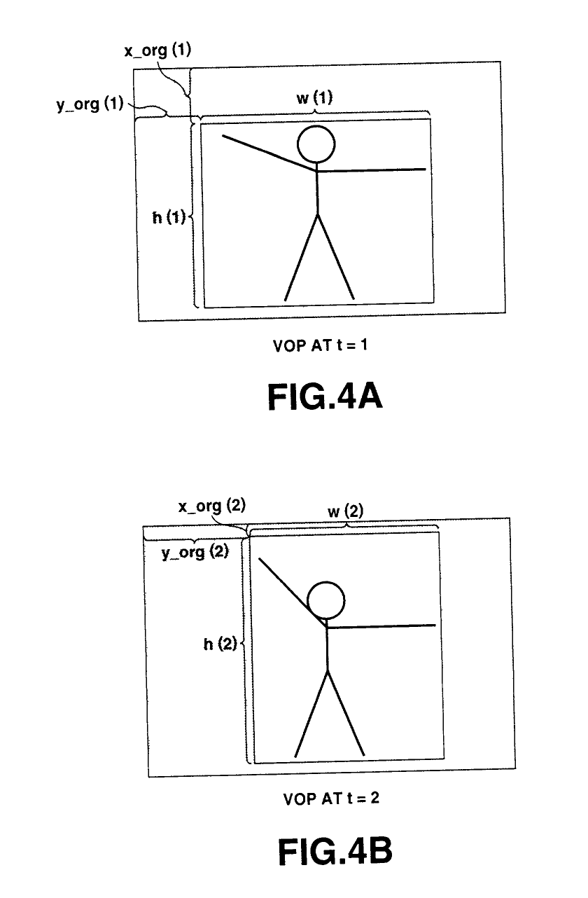

FIG. 10 illustrates three consecutive frames at t=0, t=1, and t=2 where the object (e.g. of a person) and a rectangular area of VOP which defines the object. The rectangular area consists of a number of macroblocks arranged in a grid array. As shown in FIG. 10A, the object of the person stands with its hands (or arms) extending horizontally at t=0. As the time runs from t=1shown in FIG. 10B to t=2 shown in FIG. 10C, the left hand (or arm) of the person, viewed from this side, is gradually lifted up. It is apparent from FIGS. 10A, 10B. and 10C that as the object of the person moves, the coordinate values at the upper left corner, the width, and the height of the rectangular area of VOP are varied. The frames shown in FIGS. 10C and 10D are identical in time. The frame shown in FIG. 10B is similar to that shown in FIG. 4A and the frames shown in FIGS. 10C and 10D are similar to that shown in FIG. 4A.

For encoding each macroblock in the rectangular area of the frame at t=1shifted from at t=0, the mode of the macroblock in the rectangular area in the frame at t=1has to determined according to whether the object is present or not and the motion (a change) of the object in the macroblock as compared with those in the reference macroblock in the preceding frame at t=0. When the object (or a part of the object) is not present in the macroblock in the rectangular area of the frame at t=1, the mode is selected M0 as best shown in FIG. 10B (where M0 is denoted by only 0). When the motion of the object is not changed from that of the preceding frame, the mode of the macroblock is Mskip (denoted by S in FIG. 10). When the motion of the object is slightly changed from that of the preceding frame, the mode is selected Minter (denoted by I in FIG. 10). When the motion of the object is greatly changed from that of the preceding frame, the mode is Mintra (denoted by C in FIG. 10). As apparent, the coordinate values at the upper left corner, the width, and the height of the rectangular area are unchanged between FIGS. 10A and 10B.

For encoding the macroblock in the rectangular area of the frame at t=2, it is essential to acknowledge that the coordinate values, width, and height of the rectangular area are different between FIGS. 10B and 10C. When the macroblocks in the rectangular area of the frame at t=2 are encoded, their modes are preferably assigned as shown in FIG. 10C.

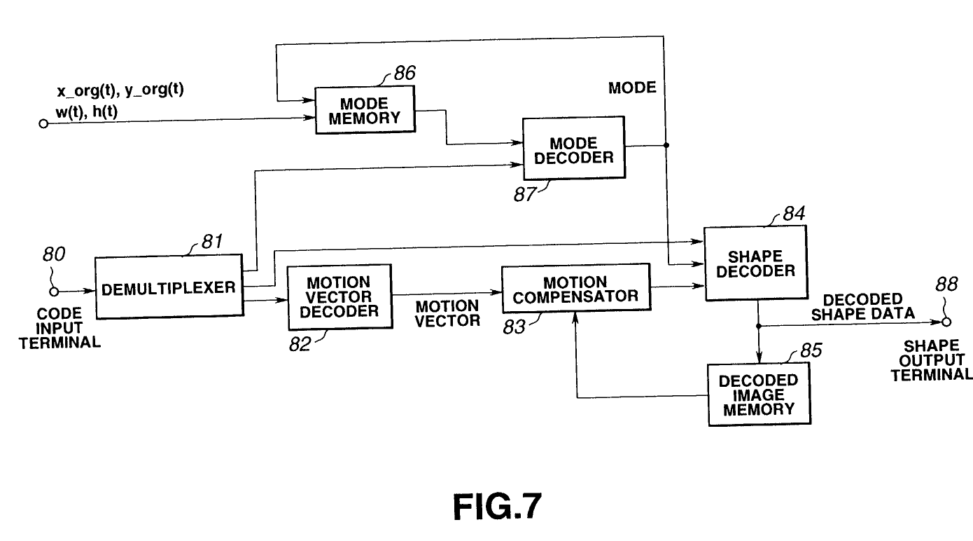

Using the reference macroblock determining method explained in conjunction with the arrangement of the first embodiment shown in FIGS. 8, 9, and 7, an array of the modes of the reference macroblocks are developed, as shown in FIG. 10D, almost perfectly corresponding to the modes of the macroblocks in the rectangular area of the frame at t=2. It is apparent from the comparison between FIG. 10C and FIG. 10D that nearly all the reference macroblocks developed by the reference macroblock determining method operated with the first embodiment of the present invention are identical in the mode to those to be encoded.

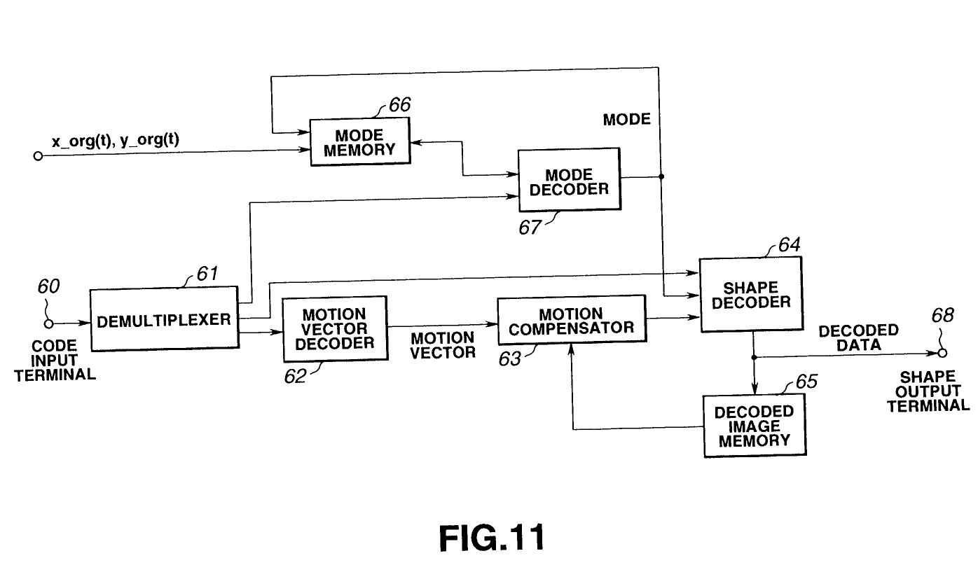

An arrangement and its operation for decoding the encoded bit steam produced by the encoding apparatus of the first embodiment shown in FIG. 8 will be described referring to FIG. 11.

The encoded bit stream which has been read from an image recording medium of the present invention or has been received from a proper transmission medium and subjected to given processes of modulation and error correction by an unshown receiver is introduced to a code input terminal 60 of a shape decoding apparatus in the arrangement of the first embodiment shown in FIG. 11.

The coded data introduced at the code input terminal 60 is decoded by the shape decoding apparatus before released as a shape data from a shape output terminal 68. The decoding in the shape decoding apparatus like the action of the encoding apparatus shown in FIG. 8 is also carried out with reference to the modes of macroblocks.

As shown in FIG. 11, the code data received at the code input terminal 60 is separated by a demultiplexer 61 to a shape data code, a motion vector code, and a macroblock mode code.

The separated codes are transferred to a shape decoder 64, a motion vector decoder 62, and a mode decoder 67 respectively.

The motion vector decoder 62 decodes the motion vector code and transmits its decoded data to a motion compensator 63. The mode decoder 67 decodes the mode code according to the mode of a reference macroblock in a reference frame which has been decoded and saved in a mode memory 66.

The mode decoder 67 also receives the coordinates values at the upper left corner of the VOP in the reference frame, the mode of the macroblock to be decoded, and the coordinate values at the upper left corner of the macroblock to be decoded. In the mode decoder 67, the coordinates values at the upper left corner of the VOP in the reference frame and the coordinate values at the upper left corner of the macroblock to be decoded are processed to determine a reference macroblock and the mode of the reference macroblock is read out from the mode memory 66. The mode decoder 67 decodes the mode of the macroblock of interest according to the mode of the reference macroblock in the reference frame. The arrangement of determining the reference macroblock is identical to that shown in FIG. 9 and will be explained in no more detail. The coordinate values at the upper left of the macroblock to be decoded may be provided either from the outside as an external signal or from any other component in the decoding apparatus.

The decoded mode of the macroblock produced by the mode decoder 67 is transferred to both the shape decoder 64 and the mode memory 66 where it is saved as the mode of the reference macroblock in the reference frame. In the mode memory 66, the coordinate values of x_org(t) and y_org(t) at the upper left corner of the rectangular area of VOP are also saved.

The motion compensator 63 produces a predictive shape data from a decoded shape data which has been reconstructed by the shape decoder 64 using the motion vector from the motion vector decoder 62 and saved in a decoded image memory 65. The predictive shape data is then supplied to the shape decoder 64.

The shape decoder 64 receives the shape data code, the decoded mode of the macroblock from the mode decoder 67, and the predictive shape data from the motion compensator 63. The shape decoder 64 decodes the shape data code of each macroblock according to the decoded mode of the macroblock and the predictive shape data. A resultant decoded form of the shape data is transferred via a shape output terminal to the outside. The shape data is also fed to the decoded image memory 65 where it is saved for future use in the motion compensator 63 to produce a predictive shape data.

A second embodiment of the present invention will be described, in which the reference to the modes of the macroblocks is different from that in the first embodiment.

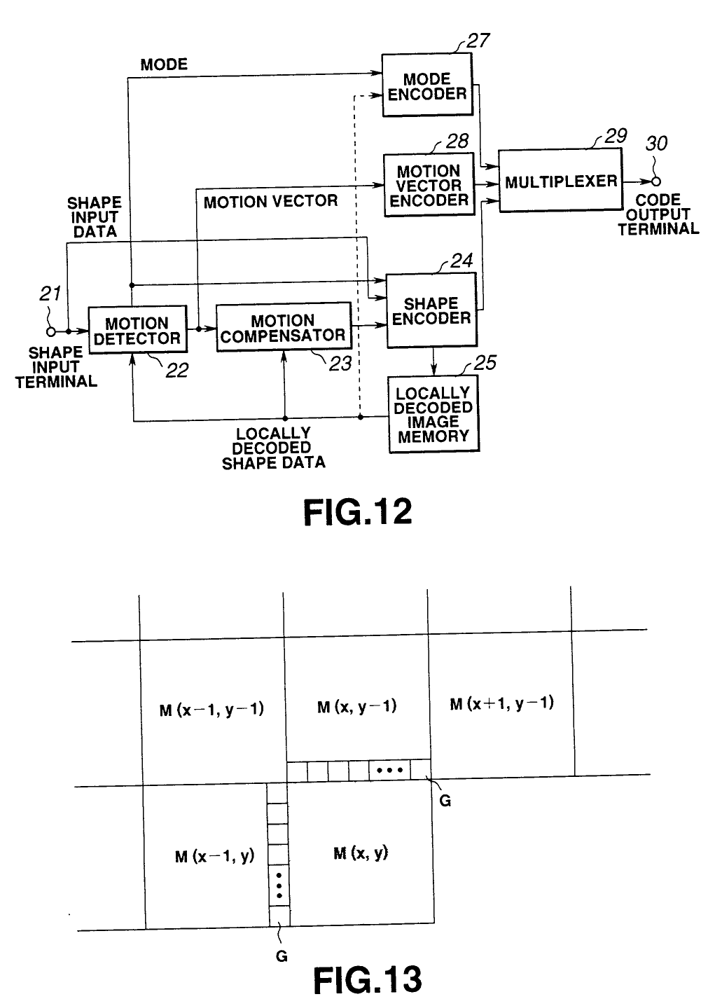

In the second embodiment, the correlation of the mode of a coded form of the (locally decoded) macroblock in the same frame is used for determining the mode of the reference macroblock. Such an action will be described in more detail referring to FIG. 12.

An image encoding apparatus (a shape encoding apparatus) shown in FIG. 12 is provided for encoding a shape data of image received at a shape input terminal 21 and delivering its coded form from a code output terminal 3 0. This encoding apparatus employs a hybrid encoding technique (such as of the MPEG standard) consisting of DCT and motion compensative prediction encoding, in which data is processed in macroblocks. The shape in the image is not encoded throughout a frame size but in a rectangular area (of VOP) which defines the shape of an object.

In action, the shape data received by the shape input terminal 21 is supplied to a motion detector 22 and a shape encoder 24.

The motion detector 22 examines a motion in each macroblock between the supplied shape data and a locally decoded shape data which has been encoded by the shape encoder 24, locally decoded, and saved in a locally decoded image memory 25. A resultant motion vector representing the motion is then released together with a mode of the macroblock. The modes of the macroblocks are identical to those explained previously and their explanation will be omitted.

The mode of the macroblock is transferred to a mode encoder 27 as well as the shape encoder 24. The motion vector is supplied to a motion vector encoder 28 and a motion compensator 23. The motion vector encoder 28 encodes the motion vector and delivers its encoded form to a multiplexer 29. The motion compensator 23 produces a predictive shape data from the locally decoded shape data saved in the locally decoded image memory 25 on the basis of the motion vector and delivers it to the shape encoder 24. In the shape decoder 24, the shape data is encoded according to the predictive shape data and the mode of the macroblock and transferred to the multiplexer 29. Also, the shape encoder 24 decodes locally the encoded shape data and feeds its locally decoded form to the locally decoded image memory 25.

The mode encoder 27 encodes the mode of the macroblock supplied according to the following procedure.

It is now assumed that the location of the macroblock, the x-th from the left end and the y-th from the upper end in a frame, is expressed by a coordinate point M(x,y). For encoding the macroblock of the coordinate point M(x,y), the mode encoder 27 uses reference to four macroblocks which are located adjacent to the macroblock to be encoded in the frame and have been encoded; an (upper left) macroblock at the coordinate point M(x−1,y−1) on the upper left side of the macroblock at M(x,y) to be encoded, an (upper) macroblock at the coordinate point M(x,y−1) on the upper side, an (upper right) macroblock at M(x+1,y−1) on the upper right side, and a (left) macroblock at M(x−1,y) on the left side, as shown in FIG. 13. According to the modes of the reference macroblocks, in case of VLC encoding process, a desired VLC table is selected or in case of arithmetic encoding process, a desired probability table is selected for the encoding. Since the mode of the macroblock to be encoded is correlated to the modes of the spatially adjacent macroblocks, its encoding will increase in the efficiency.

The encoded mode of the macroblock is then transferred to the multiplexer 29. The multiplexer 29 receives the encode shape data from the shape encoder 24 and the encoded motion vector from the motion vector encoder 28 as well as the encoded mode of each macroblock from the mode encoder 27 which are multiplexed and released from a code output terminal 30 as a steam of encoded bits.

The encoded bit stream is then added with an error correction code and subjected to given modulations before stored in a storage medium of the present invention such as CD-ROM, DVD, optical disk, magnetic disk, optomagnetic disk, RAM, or the like, or transmitted via transmission lines to a receiver not shown.

The second embodiment, unlike the first embodiment, is hence applicable not only to the interframe encoding but also to the intraframe encoding.

A third embodiment of the present invention will be described using reference to pixel values in the mode encoding with the arrangement of the second embodiment.

An arrangement of the third embodiment is modified in which a locally decoded shape data of the locally decoded image memory 25 is directly supplied to the mode encoder 27 as shown in FIG. 12. The shape encoding apparatus of the third embodiment permits the mode encoder 27 to encode the mode of each macroblock according to the following process.

Assuming that the location of the macroblock, the x-th from the left end and the y-th from the upper end in a frame, is expressed by a coordinate point M(x,y), the encoding of the mode of the macroblock at M(x,y) is based on the reference to the level of pixels G located in the macroblock at M(x,y−1) on the upper side and the macroblock at M(x−1,y) on the left side of the macroblock at M(x,y). More specifically, the pixels G allocated in the neighbor macroblocks at M(x,y−1) and M(x−1,y) in the frame which have been encoded are directly next to the macroblock to be encoded, as shown in FIG. 13.

When the level of all the pixels G allocated in the macroblocks at M(x,y−1) and M(x−1,y) is denoted by a 0 (indicating that they display a region outside the object in the frame), the mode of the macroblock at M(x,y) to be encoded is of M0 at a higher probability. When the level of all the pixels G allocated in the macroblocks at M(x,y−1) and M(x−1,y) represents a 1 (indicating that they display a region inside the object in the frame), the mode of the macroblock at M(x,y) to be encoded is very likely to be M1. When the level of the pixels G allocated in the macroblocks at M(x,y−1) and M(x−1,y) adjacent to the macroblock to be encoded includes both 0 and 1, the modes of the macroblock at M(x,y) to be encoded are very likely M0 and M1.

As the modes of the macroblocks to be encoded are different in the probability of appearance, their encoding table, either a VLC table in the VLC encoding or a probability table in the arithmetic encoding, is selectively determined corresponding to the levels or values of the pixels G in the neighbor macroblocks at M(x,y−1) and M(x−1,y). Accordingly, the third embodiment will also improve the efficiency of the encoding process.

It is also clear that the third embodiment like the second embodiment is applicable to both the interframe encoding and the intraframe encoding.

The use of the modes and the pixels of the encoded macroblocks for encoding in the second and third embodiments respectively is also favorable in the decoding process and will contribute to the accuracy of the decoding of high-efficiency coded data.

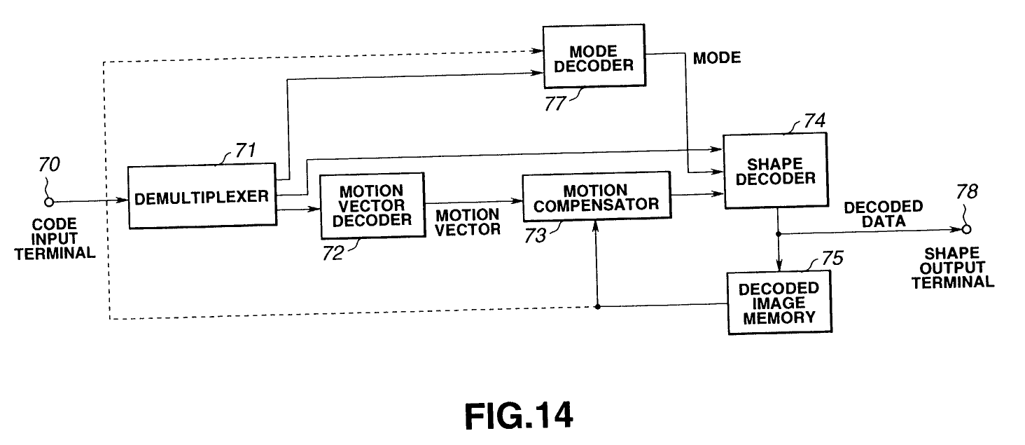

An arrangement of a decoding apparatus and its operation for decoding the encoded bit stream produced by the encoding apparatus of the second or third embodiment shown in FIG. 12 will be described referring to FIG. 14.

The coded data introduced at a code input terminal 70 is decoded by the shape decoding apparatus before released as a shape data from a shape output terminal 78. The decoding in the shape decoding apparatus like the action of the encoding apparatus shown in FIG. 12 is also carried out with reference to the modes or pixels of the preceding macroblocks.

As shown in FIG. 14, the code data received at the code input terminal 70 is separated by a demultiplexer 71 to a shape data code, a motion vector code, and a macroblock mode code.

The separated codes are transferred to a shape decoder 74, a motion vector decoder 72, and a mode decoder 77 respectively.

The motion vector decoder 72 decodes the motion vector code and transmits its decoded data to a motion compensator 73. The decoded shape data is provided from a decoded image memory 75 to the mode decoder 77. The mode decoder 77 decodes the encoded mode of the macroblock according to the modes of the neighbor macroblocks which have been decoded. More particularly, in case of the VLC decoding process, a desired VLC table is selected with reference to the modes of the neighbor macroblocks which have been decoded or in case of the arithmetic decoding process, a desired probability table is selected for the decoding The determining of the modes of the neighbor macroblocks which have been decoded is similar to that of the mode encoder 27 of the second embodiment and will be explained in no more detail.

The decoded mode of the macroblock produced by the mode decoder 77 is transferred to both the shape decoder 74.

The motion compensator 73 produces a predictive shape data from a decoded shape data which has been reconstructed by the shape decoder 74 using the motion vector from the motion vector decoder 72 and saved in the decoded image memory 75. The predictive shape data is then supplied to the shape decoder 74.

The shape decoder 74 receives the shape data code, the decoded mode of the macroblock from the mode decoder 77, and the predictive shape data from the motion compensator 73. The shape decoder 74 decodes the shape data code of each macroblock according to the decoded mode of the macroblock and the predictive shape data. A resultant decoded form of the shape data is transferred via a shape output terminal to the outside. The shape data is also fed to the decoded image memory 75 where it is saved for future use in the motion compensator 73 to produce a predictive shape data.

The shape decoding apparatus of the third embodiment allows the decoded shape data to be transferred from the decoded image memory 75 to the mode decoder 77 as denoted by the dotted line in FIG. 14. The mode decoder 77 decodes the encoded mode of the macroblock according to the level of the pixels of the neighbor macroblocks which have been decoded. More particularly, in case of the VLC decoding process, a desired VLC table is selected with reference to the level of the pixels of the neighbor macroblocks which have been decoded or in case of the arithmetic decoding process, a desired probability table is selected for the decoding. The determining of the levels of the pixels of the neighbor macroblocks which have been decoded is similar to that of the mode encoder 27 of the third embodiment and will be explained in no more detail.

The determining of the modes of the reference macroblocks and the level of the pixels of the neighbor macroblocks in the first to third embodiments may be used in any combination through adaptive switching actions. For example, the methods of determining reference data in the first and second embodiments can be used by selectively switching from one to the other. Also, the methods of determining reference data in the first and third embodiments or the second and third embodiments may be used in a combination by selectively switching from one to the other. Moreover, all the methods of the first to third embodiments may be used together by selecting a desired one at a time to carry out the encoding process at an optimum efficiency.

As set forth above, the present invention allows encoding of the mode of each code data at higher efficiency and subsequently, decoding the coded mode at higher accuracy, thus contributing to the optimum reproduction of an original image.

It would be understood that various changes and modifications are possible without departing from the scope of the present invention. It is also true that the present invention is not limited to the foregoing embodiments.

What is claimed is:

1. An image encoding method of encoding a motion picture, which consists of a plurality of time consecutive images, with the use of prediction in time between the images, and its relevant information indicative of a coding mode of each data unit of the image to be encoded to produce a coded signal, comprising the steps of:
encoding each data unit of the image to be encoded in accordance with a reference image in time; and
encoding the relevant information indicative of a coding mode of each data unit of the image to be encoded in accordance with information indicative of a coding mode of a corresponding data unit of the reference image which is most analogous to the data unit of the image to be encoded.

2. An image encoding method according to claim 1, wherein the step of encoding the information indicative of a coding mode includes adaptively switching between a first coding mode for encoding the relevant information indicative of a coding mode of each data unit of the image to be encoded in accordance with information indicative of a coding mode of a corresponding data unit of the reference image which is most analogous to the data unit of the image to be encoded and a second coding mode for encoding the relevant information indicative of a coding mode of each data unit of the image to be encoded in accordance with information indicative of a coding mode of each of data units which are spatially adjoined to the data unit of the image to be encoded.

3. An image encoding method according to claim 1, wherein the step of encoding the information indicative of a coding mode includes adaptively switching between a first coding mode for encoding the relevant information indicative of a coding mode of each data unit of the image to be encoded in accordance with information indicative of a coding mode of a corresponding data unit of the reference image which is most analogous to the data unit of the image to be encoded and a third coding mode for encoding the relevant information indicative of a coding mode of each data unit of the image to be encoded in accordance with pixels in locally decoded data units which are spatially adjoined to the data unit of the image to be encoded.

4. An image encoding method according to claim 1, wherein the step of encoding the information indicative of a coding mode includes adaptively switching between a first coding mode for encoding the relevant information indicative of a coding mode of each data unit of the image to be encoded in accordance with information indicative of a coding mode of a corresponding data unit of the reference image which is most analogous to the data unit of the image to be encoded, a second coding mode for encoding the relevant information indicative of a coding mode of each data unit of the image to be encoded in accordance with information indicative of a coding mode of each of data units which are spatially adjoined to the data unit of the image to be encoded, and a third coding mode for encoding the relevant information indicative of a coding mode of each data unit of the image to be encoded in accordance with pixels in locally encoded data units which are spatially adjoined to the data unit of the image to be encoded.

5. An image decoding method of decoding a coded signal produced by encoding a motion picture, which consists of a plurality of time consecutive images, with the use of prediction in time between the images, and its relevant information indicative of a coding mode of each data unit of the image to be encoded, comprising the steps of:
decoding the relevant information indicative of a coding mode of each data unit of the image to be decoded in accordance with information indicative of a coding mode of a corresponding data unit of a reference image which is most analogous to the data unit of the image to be decoded; and
decoding each data unit of the image to be decoded in accordance with the relevant information indicative of a coding mode of the data unit and the reference image in time.

6. An image decoding method according to claim 5, wherein the step of decoding the information indicative of a coding mode includes adaptively switching between a first decoding mode for decoding the relevant information indicative of a coding mode of each data unit of the image to be decoded in accordance with information indicative of a coding mode of a corresponding data unit of the reference image which is most analogous to the data unit of the image to be decoded and a second decoding mode for decoding the relevant information indicative of a coding mode of each data unit of the image to be decoded in accordance with information indicative of a coding mode of each of data units which are spatially adjoined to the data unit of the image to be decoded.

7. An image decoding method according to claim 5, wherein the step of decoding the information indicative of a coding mode includes adaptively switching between a first decoding mode for decoding the relevant information indicative of a coding mode of each data unit of the image to be decoded in accordance with information indicative of a coding mode of a corresponding data unit of the reference image which is most analogous to the data unit of the image to be decoded and a third decoding mode for decoding the relevant information indicative of a coding mode of each data unit of the image to be decoded in accordance with pixels in locally decoded data units which are spatially adjoined to the data unit of the image to be decoded.

8. An image decoding method according to claim 5, wherein the step of decoding the information indicative of a coding mode includes adaptively switching between a first decoding mode for decoding the relevant information indicative of a coding mode of each data unit of the image to be decoded in accordance with information indicative of a coding mode of a corresponding data unit of the reference image which is most analogous to the data unit of the image to be decoded, a second decoding mode for decoding the relevant information indicative of a coding mode of each data unit of the image to be decoded in accordance with information indicative of a coding mode of each of data units which are spatially adjoined to the data unit of the image to be decoded, and a third decoding mode for decoding the relevant information indicative of a coding mode of each data unit of the image to be decoded in accordance with pixels in locally decoded data units which are spatially adjoined to the data unit of the image to be decoded.

9. An image encoding apparatus for encoding a motion picture, which consists of a plurality of time consecutive images, with the use of prediction in time between the images, and its relevant information indicative of a coding mode of each data unit of the image to be encoded to produce a coded signal, comprising:
an image encoder for encoding each data unit of the image to be encoded in accordance with a reference image in time; and
a mode encoder for encoding the relevant information indicative of a coding mode of each data unit of the image to be encoded in accordance with information indicative of a coding mode of a corresponding data unit of the reference image which is most analogous to the data unit of the image to be encoded.

10. An image decoding apparatus for decoding a coded signal produced by encoding a motion picture, which consists of a plurality of time consecutive images, with the use of prediction in time between the images, and its relevant information indicative of a coding mode of each data unit of the image to be encoded, comprising:
a mode decoder for decoding the relevant information indicative of a coding mode of each data unit of the image to be decoded in accordance with information indicative of a coding mode of a corresponding data unit of a reference image which is most analogous to the data unit of the image to be decoded; and
an image decoder for decoding each data unit of the image to be decoded in accordance with the relevant information indicative of a coding mode of the data unit and the reference image in time.

11. A recording medium onto which recorded is a record signal which can be reproduced by a playback apparatus and particularly, includes a coded signal produced by encoding a motion picture, which consists of a plurality of time consecutive images, with the use of prediction in time between the images, and its relevant information indicative of a coding mode of each data unit of the image to be encoded, characterized in that the coded signal is processed by
decoding the relevant information indicative of a coding mode of each data unit of the image to be decoded in accordance with information indicative of a coding mode of a corresponding data unit of a reference image which is most analogous to the data unit of the image to be decoded, and
decoding each data unit of the image to be decoded in accordance with the relevant information indicative of a coding mode of the data unit and the reference image in time.

12. An image encoding method of encoding an input image and its relevant information indicative of a coding mode of each data unit of the image to be encoded to produce a coded signal, comprising the steps of:
encoding each data unit of the image to be encoded; and
encoding the relevant information indicative of a coding mode each data unit of the image to be encoded in accordance with information indicative of a coding mode of each of encoded data units which are spatially adjoined to the data unit of the image to be encoded.

13. An image encoding method according to claim 12, wherein the step of encoding the information indicative of a coding mode includes adaptively switching between a first coding mode for encoding the relevant information indicative of a coding mode of each data unit of the image to be encoded in accordance with information indicative of a coding mode of each of data units which are spatially adjoined to the data unit of the image to be encoded and a second coding mode for encoding the relevant information indicative of a coding mode of each data unit of the image to be encoded in accordance with pixels in locally decoded data units which are spatially adjoined to the data unit of the image to be encoded.

14. An image decoding method of decoding a coded signal produced by encoding an input image and its relevant information indicative of a coding mode of each data unit of the image to be encoded, comprising the steps of:
decoding the relevant information indicative of a coding mode of each data unit of the image to be decoded in accordance with information indicative of a coding mode of each of data units which are spatially adjoined to the data unit of the image to be decoded; and
decoding each data unit of the image to be decoded in accordance with the decoded relevant information indicative of a coding mode of the data unit.

15. An image decoding method according to claim 14, wherein the step of decoding the information indicative of a coding mode includes adaptively switching between a first decoding mode for decoding the relevant information indicative of a coding mode of each data unit of the image to be decoded in accordance with information indicative of a coding mode of each of data units which are spatially adjoined to the data unit of the image to be decoded and a second decoding mode for decoding the relevant information indicative of a coding mode of each data unit of the image to be decoded in accordance with pixels in locally decoded data units which are spatially adjoined to the data unit of the image to be decoded.

16. An image encoding apparatus for encoding an input image and its relevant information indicative of a coding mode of each data unit of the image to be encoded to produce a coded signal, comprising:
an image encoder for encoding each data unit of the image to be encoded; and
a mode encoder for encoding the relevant information indicative of a coding mode each data unit of the image to be encoded in accordance with information indicative of a coding mode of each of encoded data units which are spatially adjoined to the data unit of the image to be encoded.

17. An image decoding apparatus for decoding a coded signal produced by encoding an input image and its relevant information indicative of a coding mode of each data unit of the image to be encoded, comprising:
a mode decoder for decoding the relevant information indicative of a coding mode of each data unit of the image to be decoded in accordance with information indicative of a coding mode of each of data units which are spatially adjoined to the data unit of the image to be decoded; and
an image decoder for decoding each data unit of the image to be decoded in accordance with the decoded relevant information indicative of a coding mode of the data unit.

18. A recording medium onto which recorded is a record signal which can be reproduced by a playback apparatus and particularly, includes a coded signal produced by encoding an input image and its relevant information indicative of a coding mode of each data unit of the image to be encoded, characterized in that the coded signal is processed by
decoding the relevant information indicative of a coding mode of each data unit of the image to be decoded in accordance with information indicative of a coding mode of each of data units which are spatially adjoined to the data unit of the image to be decoded, and
decoding each data unit of the image to be decoded in accordance with the decoded relevant information indicative of a coding mode of the data unit.

19. An image encoding method of encoding an input image and its relevant information indicative of a coding mode of each data unit of the image to be encoded to produce a coded signal, comprising the steps of:
encoding each data unit of the image to be encoded; and
encoding the relevant information indicative of a coding mode each data unit of the image to be encoded in accordance with pixels in locally decoded data units which are spatially adjoined to the data unit of the image to be encoded.

20. An image decoding method of decoding a coded signal produced by encoding an input image and its relevant information indicative of a coding mode of each data unit of the image to be encoded, comprising the steps of:
decoding the relevant information indicative of a coding mode of each data unit of the image to be decoded in accordance with pixels in locally decoded data units which are spatially adjoined to the data unit of the image to be decoded; and
decoding each data unit of the image to be decoded in accordance with the decoded relevant information indicative of a coding mode of the data unit.

21. An image encoding apparatus for encoding an input image and its relevant information indicative of a coding mode of each data unit of the image to be encoded to produce a coded signal, comprising:
an image encoder for encoding each data unit of the image to be encoded; and
a mode encoder for encoding the relevant information indicative of a coding mode each data unit of the image to be encoded in accordance with pixels in locally decoded data units which are spatially adjoined to the data unit of the image to be encoded.

22. An image decoding apparatus for decoding a coded signal produced by encoding an input image and its relevant information indicative of a coding mode of each data unit of the image to be encoded, comprising:
a mode decoder for decoding the relevant information indicative of a coding mode of each data unit of the image to be decoded in accordance with pixels in locally decode data units which are spatially adjoined to the data unit of the image to be decoded; and
an image decoder for decoding each data unit of the image to be decoded in accordance with the decoded relevant information indicative of a coding mode of the data unit.

23. A recording medium onto which recorded is a record signal which can be reproduced by a playback apparatus and particularly, includes a coded signal produced by encoding an input image and its relevant information indicative of a coding mode of each data unit of the image to be encoded, characterized in that the coded signal is processed by
decoding the relevant information indicative of a coding mode of each data unit of the image to be decoded in accordance with pixels in locally decoded data units which are spatially adjoined to the data unit of the image to be decoded, and
decoding each data unit of the image to be decoded in accordance with the decoded relevant information indicative of a coding mode of the data unit.
